(19) United States
(12) Patent Application Publication
(10) Pub. No.: US 2024/0158683 A1
(43) Pub. Date: May 16, 2024

(54) METHODS AND SYSTEMS ASSOCIATED WITH A DRY LUBRICANT

(71) Applicant: SciDev Energy Services, Inc., Houston, TX (US)

(72) Inventors: Shawn Lu, Katy, TX (US); Kevin Wilbur Smith, Bellaire, TX (US)

(21) Appl. No.: 18/388,943

(22) Filed: Nov. 13, 2023

Related U.S. Application Data
(60) Provisional application No. 63/425,710, filed on Nov. 16, 2022.

(51) Int. Cl. C09K 8/12

(52) U.S. Cl. CPC C09K 8/12; C09K 2208/28

(57) ABSTRACT

A lubricant in dry form, which can be blended with other dry additives such as bentonite, or polymers like xanthan, PAC, and PHPA. The lubricant in dry form may allow for handling at low temperatures with no pour point issues in aqueous situations, which will reduce the torque and ensure a good penetration rate.

### BACKGROUND INFORMATION

### Field of the Disclosure

Examples of the present disclosure relate to systems and methods associated with utilizing a lubricant in dry form for water-based drilling fluid, which can be blended with other dry additives such as bentonite, or polymers like xanthan, PAC, and PHPA.

### Background

Drilling is a common operation in many industries from oil and gas. During the drilling, drilling fluids are often circulated in the wellbore to achieve various functions from transporting cuttings, maintaining formation pressures, and cooling down the drill bit. Friction control is a key parameter while drilling and friction often limits the rate of penetration by causing a buildup of solids within the slurry and increasing the temperature of the slurry. Various chemistries have been added to drilling fluids to reduce the friction between metal-to-metal and metal-to-formations.

Lubricants are often required to reduce metal-to-metal or metal-to-rock friction as water, brines, or water-based fluids that have a high friction coefficient during drilling applications such as oil and gas industry or mining. The addition of a lubricant can effectively reduce the torque and ensure a good penetration rate. The performance of lubricants is determined by the chemistry and the compatibility with the fluid composition. Lubricants can contain a wide range of chemistry from simple hydrocarbon to specially designed additives.

However, typically lubricants are in liquid form, and not in solid form. These liquid lubricants require a high pour point.

The performance of friction reducers is a key factor for the success of fracturing operations. Conventional friction reducers, generally include dry powder, polymer emulsion, and polymer slurry suspended in a base fluid. Polymer slurry suspension provides flexibility in product formulation and eliminates the difficulties of handling dry production during hydraulic fracturing.

Accordingly, needs exist for systems and methods associated with dry lubricants for aqueous drilling fluids that have a low pour point, wherein the dry lubricant utilized in aqueous situations may be a spray-dried product including neutralized carboxylic acid terminated fatty amine condensate or a neutralized modified tall oil or a mixture of two.

### SUMMARY

Embodiments are directed towards a dry lubricant utilized in aqueous situations may be a spray-dried product including neutralized carboxylic acid terminated fatty amine condensate or a neutralized modified tall oil or a mixture of two. The dry lubricant may be configured to lower the coefficient of friction and increase the lubricity of bentonite mud. Embodiments may be configured to greatly improve ultimate viscosity while cutting polymer hydration time in half. In embodiments, the dry lubricant may be configured to disperse dry polymers within the drilling fluid quickly and more efficiently, which can be used in any water-based drilling fluid.

A first embodiment of the dry lubricant may be a spray-dried product that is a neutralized carboxylic acid terminated fatty amine condensate or a neutralized modified tall oil or a mixture of two.

A second embodiment of a dry lubricant may include a 50/50 mixture of the first embodiment and an organophilic starch, wherein the organophilic starch is a modified starch that makes is dispersible in oil.

Embodiments may be configured to lower the coefficient of friction (COF) in compared to a liquid lubricant in tap water when used in aqueous drilling fluid. Specifically, after adding more than a de minimis amount of embodiments to the drilling fluid, the COF may be reduced. Furthermore, embodiments may be configured to enhance the hydration of friction reducers, which may be a polyacrylamide. Specifically, embodiments may help wet or disperse the polymer particles and thus yields a better hydration.

More so, dry lubricants have been used as an emulsifier for oil-based drilling, and organophilic starch has been used as a fluid loss control agent for non-aqueous drilling fluids. However, the dry lubricants and organophilic starch have not been used in aqueous-based drilling fluid, and it would not have been obvious to do so. Specifically, the chemistry of emulsifiers and organophilic starch are designed to work in non-aqueous fluids. Using such chemistry in aqueous fluids to improve the lubricity is not obvious

Specific embodiments may improve dry friction reducer handling, hydration and viscosity. The dry lubricant may act as an associative thickener, and allowing the addition of unground powder directly into a flow loop with immediate friction reduction. When compared to even a coarsely ground friction reducer, unground friction reducer flows more easily, does not pack off chutes, etc. and there is less dust. The other benefit is performance. The chemistry boosts the viscosity and dispersibility of polyacrylamides.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions, or rearrangements may be made within the scope of the invention, and the invention includes all such substitutions, modifications, additions, or rearrangements.

### BRIEF DESCRIPTION OF THE DRAWINGS

Non-limiting and non-exhaustive embodiments of the present invention are described concerning the following figures, wherein reference numerals refer to like parts throughout the various views unless otherwise specified.

FIG. 1 depicts a method for adding dry lubricant to aqueous drilling fluid to reduce the CoF of mud, according to an embodiment.

FIG. 2 depicts a table illustrating the utilization of a dry lubricant in aqueous drilling fluids, according to an embodiment.

FIG. 3 depicts a table illustrating the utilization of dry lubricants in aqueous drilling fluids in bentonite mud, according to an embodiment.

FIG. 4 depicts a table illustrating the utilization of dry lubricants in aqueous drilling fluids in a polymer mud, according to an embodiment.

FIG. 5 depicts a graph illustrating the friction reduction % (Y-axis) vs. composition dosage (X-axis) of a dry lubricant in bentonite mud, according to an embodiment.

FIG. 6 depicts a graph illustrating the friction reduction % (Y-axis) vs. composition dosage (X-axis) of a dry lubricant in a bentonite mud and a polymer mud, according to an embodiment.

FIG. 7 depicts a graph illustrating the friction reduction % (Y-axis) vs. time (X-axis) of a dry lubricant, according to an embodiment.

FIG. 8 depicts a table illustrating the viscosity development of a dry anionic lubricant after adding it to fresh water, according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present disclosure. Also, common but well-understood elements that are useful or necessary in a commercially feasible embodiment are often not depicted to facilitate a less obstructed view of these various embodiments of the present disclosure.

### DETAILED DESCRIPTION

In the following description, numerous specific details are outlined to provide a thorough understanding of the present embodiments. It will be apparent, however, to one having ordinary skill in the art, that the specific detail need not be employed to practice the present embodiments. In other instances, well-known materials or methods have not been described in detail to avoid obscuring the present embodiments.

Embodiments may be directed towards a composition of a dry lubricant to lower a CoF of mud in aqueous drilling fluids.

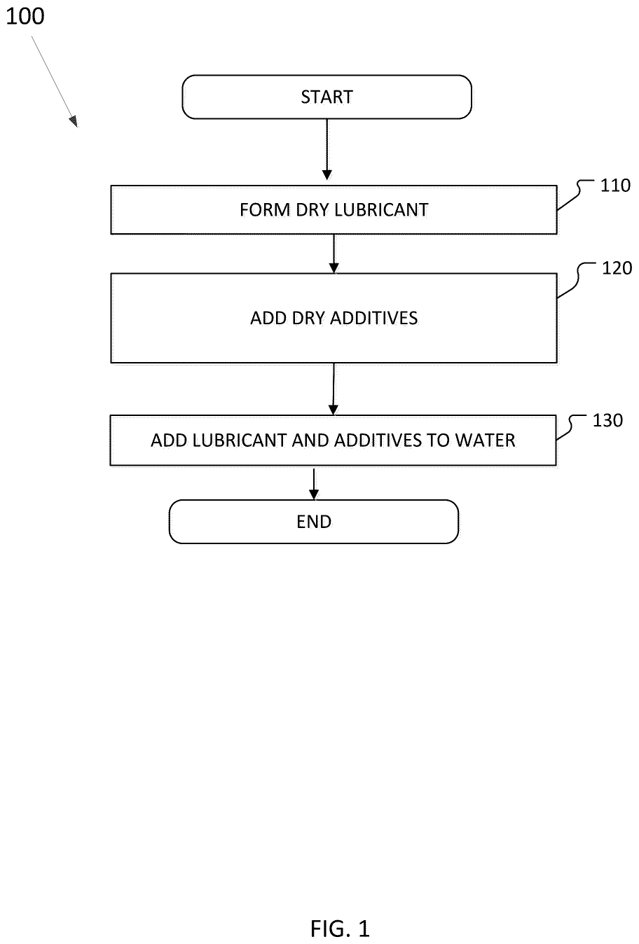

FIG. 1 depicts method 100 to utilize a dry lubricant in aqueous-based drilling fluids for a novel method. The operations of method 100 presented below are intended to be illustrative. In some embodiments, method 100 may be accomplished with one or more additional operations not described, and/or without one or more of the operations discussed. Additionally, the order in which the operations of method 100 are illustrated in FIG. 1 and described below is not intended to be limiting.

At operation 110, a dry lubricant may be formed. The first embodiment of dry lubricant may be a spray-dried product that is a neutralized carboxylic acid terminated fatty amine condensate or a neutralized modified tall oil or a mixture of two. Alliteratively, a dry lubricant may include a 50/50 mixture of the first embodiment and an organophilic starch, wherein the organophilic starch is a modified starch that makes it dispersible in oil.

At operation 120, the dry lubricant may be used as an additive with dry polyacrylamide to enhance the dispersion and hydration of the polymer when added to water. In further embodiments, the dry lubricant may be blended with other dry additives, such as bentonite or polymers including xanthan, PAC, and PHPA

At operation 130, the dry lubricant and the dry additives may be added to water, wherein the dry lubricant may reduce the CoF of the mud, and add to the lubricity of the dry additives.

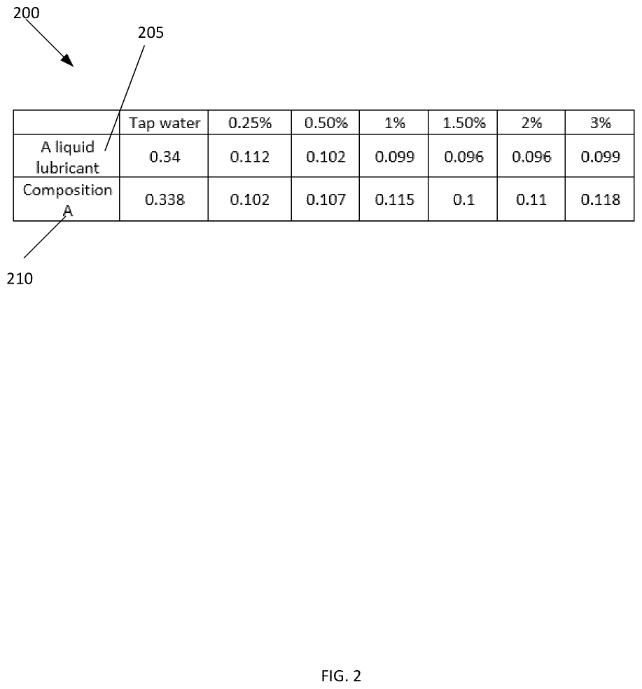

FIG. 2 depicts table 200 illustrating the utilization of a dry lubricant in aqueous drilling fluids, according to an embodiment.

A first composition 210 of the dry lubricant may be a spray-dried product that is a neutralized carboxylic acid terminated fatty amine condensate or a neutralized modified tall oil or a mixture of two. The first composition 210 of dry lubricant may be configured to reduce the CoF of tap water from 0.338 to 0.192 after 0.25% of the total fluid is formed of the first composition 210. The first composition 210 of the dry lubricant may also be configured to reduce the CoF of the tap water from 0.338 to 0.118 after 3% of the total fluid is formed of the first composition 210. On the other hand, when a standard liquid lubricant 205 is added to tap water the CoF of the tape water may be 0.112 after 0.25% of the total fluid is formed of the liquid lubricant 205, and the CoF of the tap water may be reduced to 0.099 after 3% of the total fluid is formed of the liquid lubricant 2.5.

To this end, the first composition 210 may be superior to the liquid lubricant 205 when using a very small amount of the first composition 210, wherein the CoF of the tap water may increase as more of the first composition 210 is added to the tap water. Accordingly, much less of the first composition 210 is necessary to achieve the same level of CoF as a conventional liquid lubricant 205.

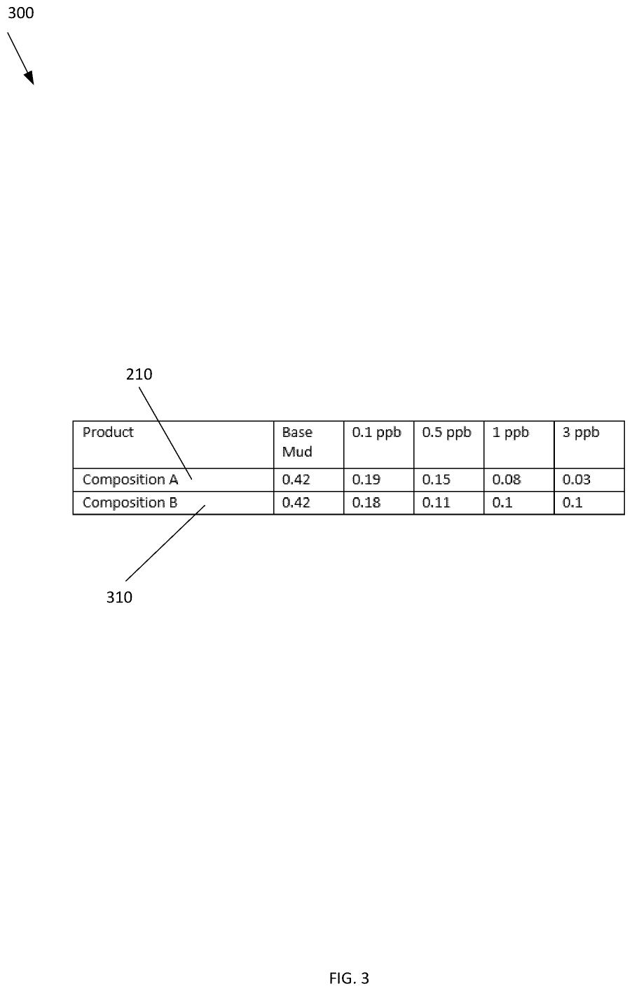

FIG. 3 depicts table 300 illustrating the utilization of dry lubricants in aqueous drilling fluids in bentonite mud, according to an embodiment.

In embodiments, a second composition 310 a dry lubricant may include a 50/50 mixture of the first composition 210 and an organophilic starch, wherein the organophilic starch is a modified starch that makes it dispersible in oil. As depicted in Table 300 both the first composition 210 and the second composition 310 decrease the CoF of a bentonite mud as more of the first composition 210 or the second composition 310 is added. However, the second composition 310 may be even more efficient and effective at lower CoF of the bentonite mud when compared to the first composition 210 at low levels of ppb of the drilling fluid. Specifically, the ppb is pound per barrel in drilling fluids, and friction reducers are not used in drilling fluids.

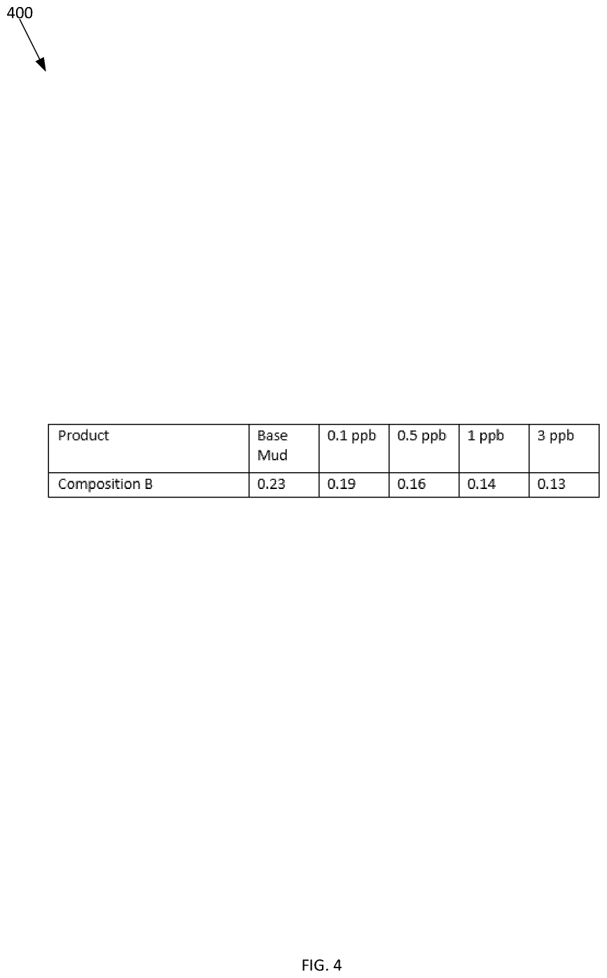

FIG. 4 depicts table 400 illustrating the utilization of dry lubricants in aqueous drilling fluids in a polymer mud, according to an embodiment.

As depicted in Table 400 the second composition 310 a dry lubricant may be even very efficient and effective at lowering the CoF of the polymer mud, which may be decreasing even after the second position 310 increases to 3 ppb of the drilling fluid.

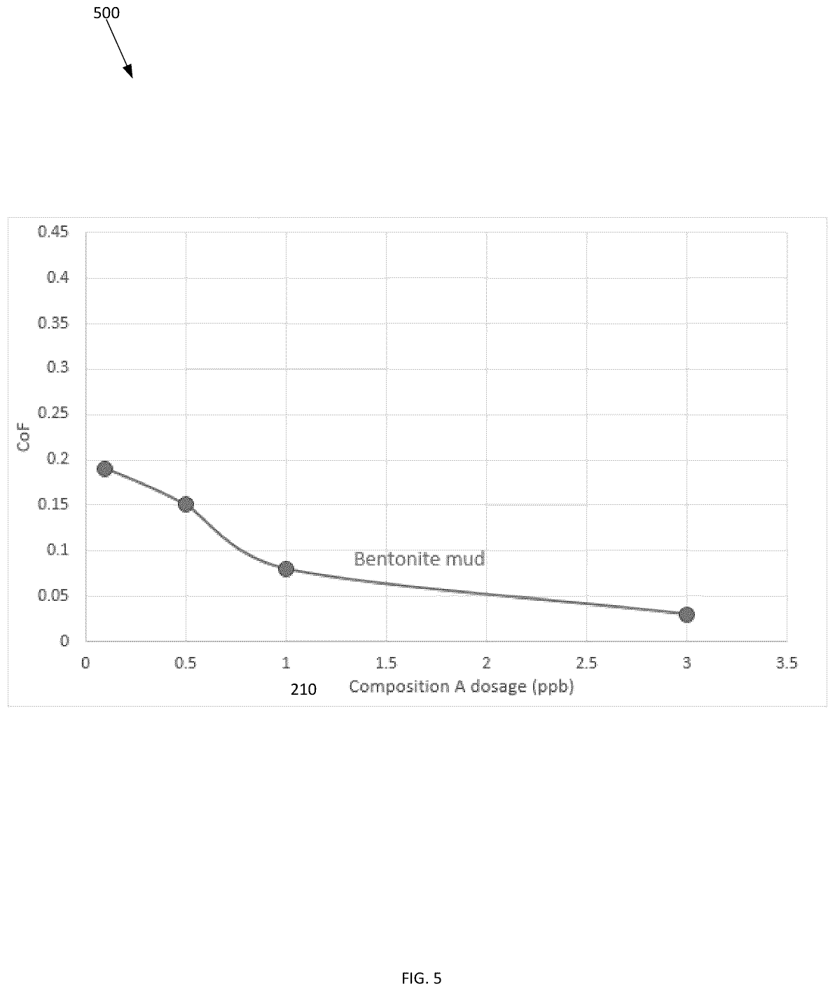

FIG. 5 depicts graph 500 illustrating the friction reduction % (Y-axis) vs. composition dosage (X-axis) of the first dry lubricant 210 in bentonite mud, according to an embodiment.

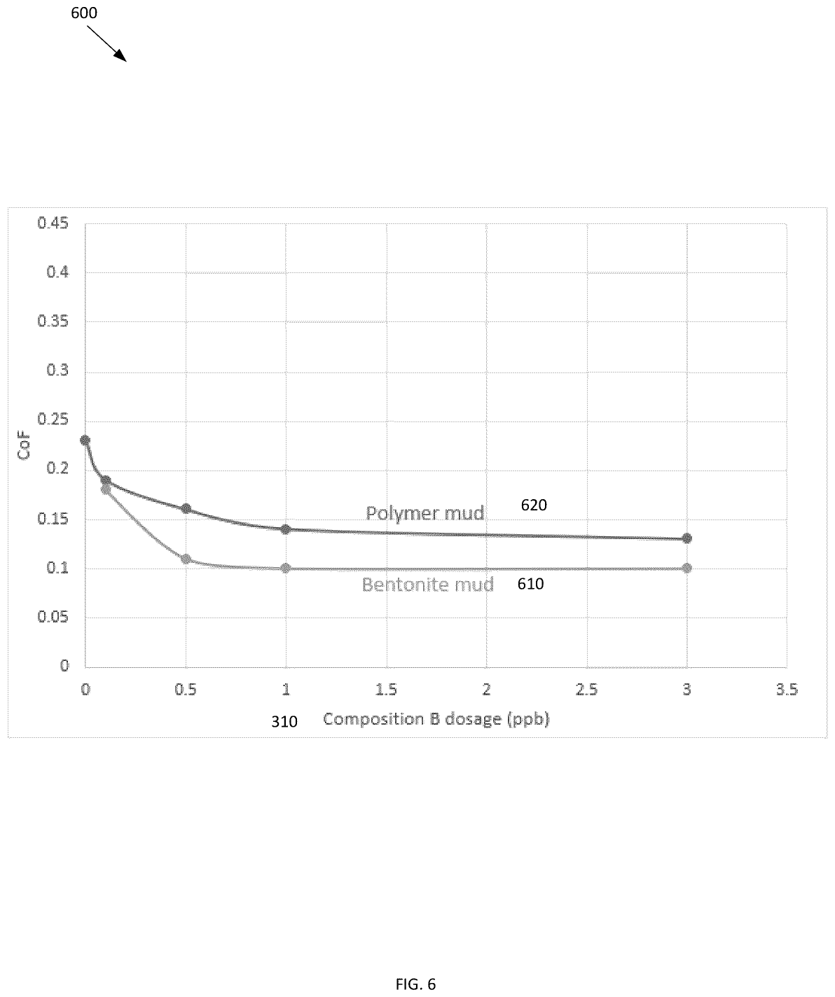

FIG. 6 depicts graph 600 illustrating the friction reduction % (Y-axis) vs. composition dosage (X-axis) of the second dry lubricant 310 in a bentonite mud 610 and a polymer mud 620, according to an embodiment.

As depicted in FIGS. 5 and 6, at some point (around 0.5 ppb) there is minimal incentive to keep adding the first dry lubricant or the second dry lubricant 310 to the drilling fluid due to the CoF remaining substantially constant.

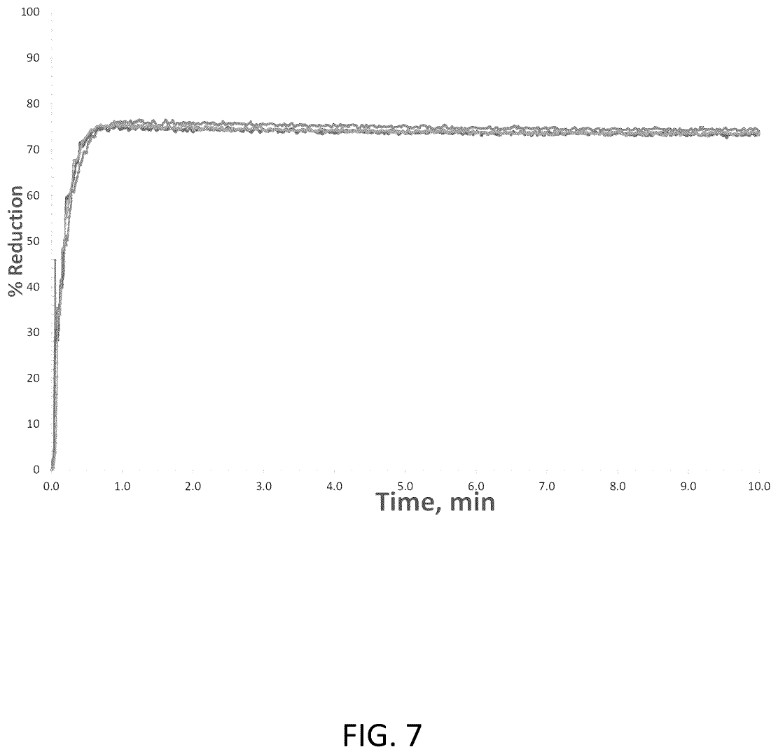

FIG. 7 depicts graph 700 illustrating the friction reduction % (Y-axis) vs. time (X-axis) of the first dry lubricant 210, according to an embodiment.

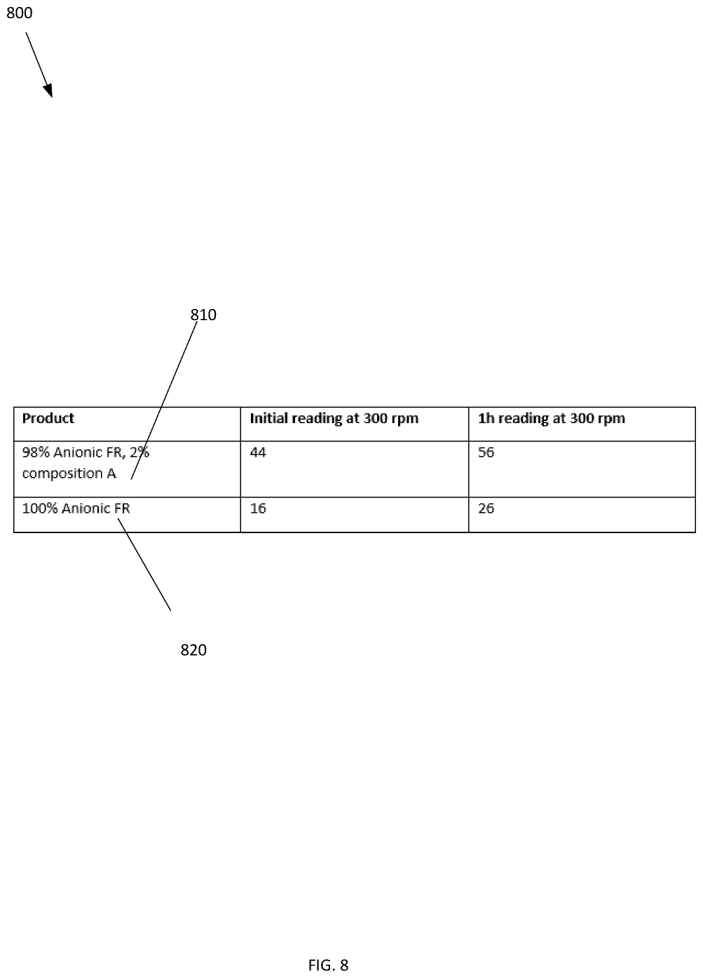

FIG. 8 depicts table 800 illustrating the viscosity development of a dry anionic lubricant after adding it to fresh water, according to an embodiment.

Table 800 depicts the viscosity of a polymer solution that forms 1% of the drilling fluid with 810 and without 820 the first dry lubricant 210. As depicted in Table 800, the viscosity of a dry anionic lubricant after adding it to freshwater, wherein the presence of the first lubricant 210 enhances the hydration of the friction reducer, which is a polyacrylamide.

Reference throughout this specification to “one embodiment”, “an embodiment”, “one example” or “an example” means that a particular feature, structure, or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures, or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Although the present technology has been described in detail for illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A method of using a dry lubricant used in aqueous drilling fluids, the method comprising:
forming the dry lubricant, the dry lubricant being carboxylic acid terminated fatty amine condensate;
adding the dry lubricant to water;
reducing a coefficient of friction of the mud when lower amounts of the dry lubricant are added to the water.

2. The method of claim 1, wherein the coefficient of friction of the mud is lower when the dry lubricant forms 0.25% of drilling fluid compared to when the dry lubricant forms 1% of the drilling fluid.

3. The method of claim 2, further comprising:
enhancing a hydration a friction reducer via the dry lubricant, wherein the friction reducer is a polyacrylamide.

4. The method of claim 1, further comprising:
blending the dry lubricant with other additives.

5. The method of claim 5, wherein the other additives are bentonite or polymers.

6. The method of claim 1, wherein forming the dry lubricant includes adding an organophilic starch to the carboxylic acid terminated fatty amine condensate at a 50/50 ratio.

7. A method of using a dry lubricant used in aqueous drilling fluids, the method comprising:
forming the dry lubricant, the dry lubricant being a neutralized modified tall oil;
adding the dry lubricant to water;
reducing a coefficient of friction of the mud when lower amounts of the dry lubricant are added to the water.

8. The method of claim 7, wherein forming the dry lubricant includes adding an organophilic starch to the carboxylic acid terminated fatty amine condensate at a 50/50 ratio.

9. The method of claim 7, wherein the dry lubricant decreases the friction of coefficient of mud until the dry lubricant forms three parts per billion of the drilling fluid.
